(19) United States
(12) Patent Application Publication
(10) Pub. No.: US 2005/0134564 A1
(43) Pub. Date: Jun. 23, 2005

(54) Touch type mouse structure

(75) Inventor: Bill Huang, Taipei (TW)

Correspondence Address: BACON & THOMAS, PLLC, 625 SLATERS LANE, FOURTH FLOOR, ALEXANDRIA, VA, 22314, US

(73) Assignee: Chic Technology Corp., Taipei (TW)

(21) Appl. No.: 10/739,076

(22) Filed: Dec. 19, 2003

(51) Int. Cl. G09G 5/08

(52) U.S. Cl. 345/163

(57) ABSTRACT

The present invention relates to a touch type mouse structure, especially one using fingers to interrupt light and simultaneously press mouse function keys. The structure mainly consists of four pressing points matched with an inner light sensor wherein the four pressing points form a concave body, illuminating at the conducting bar at the concave edge. The bottom edge allows light to pass through for reaction of inner sensor. The inner sensor is surrounded by the conducting bar material on the outside and interrupting materials inside and is designed at the center of each pressing point and connected to the inner circuit of the mouse. Hence, the present invention provides a convenient and easy way to simultaneously press function keys and interrupt light for soundless control effect. It is the most modern design as there are no conjunctions between the touch keys interface, thus avoiding dust and other residue.

### BACKGROUND OF THE INVENTION

1.Field of the invention

The present invention relates to a touch type mouse structure, especially one using fingers to interrupt light and simultaneous press mouse function keys.

2. Description of the related art

Commonly used desktop mouse press control key structures are mechanically designed and some noise will be emitted when the keys are being operated. This kind of situation is quite disturbing, especially at night and since the noise sounds like the traditional typewriter, much improvement is therefore necessary.

The above-mentioned mechanical press control key structures and rollers are operated independently and some space need to be left beforehand for rebounding action and therefore, dust and other residues can easily smudge on.

### SUMMARY OF THE INVENTION

The present invention relates to a touch type mouse structure mainly consisting of four pressing points matched with an inner sensor wherein the four pressing points forms a concave body, illuminating at the conducting bar of the concave edge. The bottom edge allows light to pass through for reaction of the inner sensor.

The present invention relates to a touch type mouse structure mainly consisting of four pressing points matched with an inner sensor wherein the sensor is surrounded by the conducting bar material on the outside and the light interrupting material on the inside. The sensor is designed at the center of each pressing point and connected to the build-in circuit of the mouse.

### A BRIEF DESCRIPTION OF DRAWINGS

FIG. 1 shows a plan of the commonly used mouse structure.

FIG. 2 shows a plan of the control principles of the present invention.

FIG. 3 shows a sectional view of the structure of the present invention.

FIG. 4 shows a plan of the sensor location.

### DETAILED DESCRIPTION OF THE INVENTION

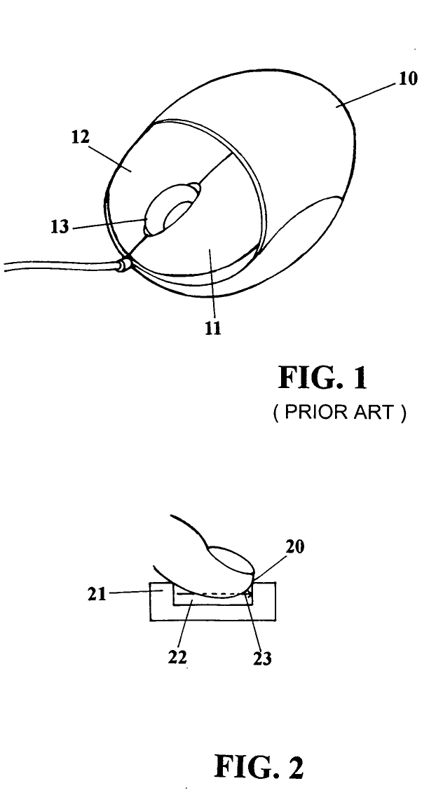

With reference to FIG. 1 showing a plan of the commonly used mouse structure, a gap is left beforehand between the left control key 11 and right control key 12 of mouse 10 and the four rollers 13 are similar at every angle for convenient pressing and rolling. However, since this kind of structure is designed mechanically, some noise will be emitted while in use and the gap in-between the keys interface easily keep dust as well as other residue thus influencing work quality and proper mouse function. With further reference to FIG. 2 showing a plan of the control principles of the present invention, when pressing point is being pressed by finger 20, the sensor zone 22 of the concave body is being covered and light 23 interrupted.

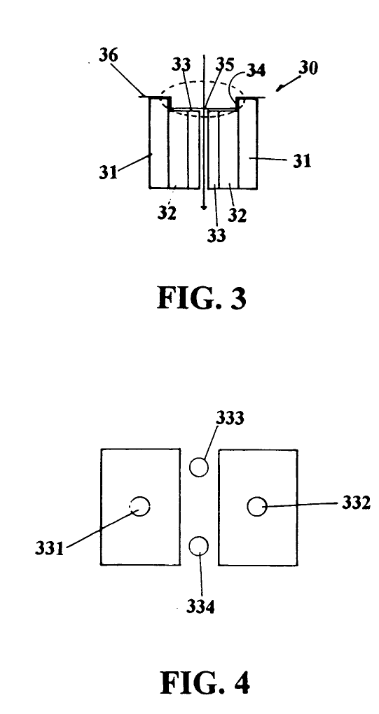

With more reference to FIG. 3 and FIG. 4 showing a sectional view of the structure of the present invention and a plan of the sensor location, the structure of a pressing point 30 mainly consists of surrounding conducting bar 31 on the outside, interrupting light material 32 in the middle and light sensor 33. The conducting bar 31 is slightly higher using the top convex edge 34 for light such that the interrupting material 32 cannot cover light from the top edge for reaction of the light sensor 33 found at the center of the bottom edge 35. The control key interface is designed in a round concave shape body for convenient touching and covering and a pass-through light layer 36 added for special dust and water-proof function.

With further reference to FIG. 4, the sensor 33 is placed according to the location of function keys such as left key light sensor 331, right key light sensor 332, upper roller key sensor 333 and down roller key sensor 334 as shown in the diagram. The top edge is used to respond to light interruption of the light sensing zone and the other edge is directly connected to the inner circuit of the mouse. In addition, if music lovers cannot adapt to the soundless effect, a software can easily resolve such a problem and different touching keys can emit different kinds of animals' sounds. Hence, the present invention provides a very modernized mouse structure using the finger to touch function keys and interrupt light for silent effect. The key table is also designed with a pass-through light layer such that there are no gaps in-between the keys to avoid dust and other residues.

1. A touch type mouse structure mainly consisting of four pressing points matched with an inner light sensor, wherein:
The four pressing points form a concave body, illuminating at the conducting bar at the concave edge, the bottom edge allows light to pass through for reaction of inner sensor, the inner sensor is surrounded by the conducting bar material on the outside and interrupting materials inside and is designed at the center of each pressing point and connected to the inner circuit of the mouse, as characterized.

2. A touch type mouse structure according to claim 1, wherein the structure of a pressing point mainly consists of surrounding conducting bar on the outside, interrupting light material in the middle and light sensor, the conducting bar is slightly higher using the top convex edge for light such that the interrupting material cannot cover light from the top edge for reaction of the light sensor found at the center of the bottom edge, the control key interface is designed in a round concave shape body for convenient touching and covering and a pass-through light layer added for special dust and water-proof function.

3. A touch type mouse structure according to claim 1, wherein the light sensor is placed according to the location of the function keys.
